(19) United States
(12) Patent Application Publication
(10) Pub. No.: US 2023/0370212 A1
(43) Pub. Date: Nov. 16, 2023

(54) BIT LOADING WITH DFT-S-OFDM

(71) Applicant: QUALCOMM Incorporated, San Diego, CA (US)

(72) Inventors: Idan Michael HORN, Hod Hasharon (IL); Assaf TOUBOUL, Netanya (IL); Michael LEVITSKY, Rehovot (IL); Shay LANDIS, Hod Hasharon (IL)

(21) Appl. No.: 17/663,627

(22) Filed: May 16, 2022

(51) Int. Cl. H04L 5/00; H04W 28/02

(52) U.S. Cl. CPC H04L 5/0007; H04L 5/0064; H04L 5/0041; H04L 5/0098; H04W 28/0215

(57) ABSTRACT

Apparatus, methods, and computer program products for communications based on DFT-s-OFDM are provided. An example method may include transmitting a capability indication associated with a support for multiple DFT-s-OFDM to a network entity. The example method may further include receiving an activation associated with the multiple DFT or the multiple IDFT from the network entity, the activation indicating two or more bandwidth parts (BWPs). The example method may further include transmitting or receiving a DFT-s-OFDM waveform associated with the multiple DFT or the multiple IDFT in the two or more BWPs with a dedicated DFT or a dedicated IDFT for each BWP of the two or more BWPs.

### TECHNICAL FIELD

The present disclosure relates generally to communication systems, and more particularly, to wireless communication systems with multiple discrete Fourier transform (DFT) or multiple inverse discrete Fourier transform (IDFT) for DFT spread orthogonal frequency division multiplexing (DFT-s-OFDM).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to transmit a capability indication associated with a support for multiple discrete Fourier transform (DFT) or multiple inverse discrete Fourier transform (IDFT) for DFT spread orthogonal frequency division multiplexing (DFT-s-OFDM) to a network entity. The memory and the at least one processor coupled to the memory may be further configured to receive an activation associated with the multiple DFT or the multiple IDFT from the network entity, the activation indicating two or more bandwidth parts (BWPs). The memory and the at least one processor coupled to the memory may be further configured to transmit or receive a DFT-s-OFDM waveform associated with the multiple DFT or the multiple IDFT in the two or more BWPs with a dedicated DFT or a dedicated IDFT for each BWP of the two or more BWPs.

In another aspect of the disclosure, a method, a computer-readable medium, and an apparatus at a network entity are provided. The apparatus may include a memory and at least one processor coupled to the memory. The memory and the at least one processor coupled to the memory may be configured to receive, at connection establishment with a UE, a capability indication associated with a support for multiple DFT or multiple IDFT for DFT-s-OFDM. The memory and the at least one processor coupled to the memory may be further configured to transmit an activation associated with the multiple DFT or the multiple IDFT for the UE, the activation indicating two or more BWPs. The memory and the at least one processor coupled to the memory may be further configured to transmit or receive a DFT-s-OFDM waveform associated with a dedicated DFT or a dedicated IDFT in each of the two or more BWPs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B illustrate example 4 ports channel frequency domain respond.

FIGS. 5A and 5B illustrate example 4 ports channel frequency domain respond.

FIG. 6 is a diagram illustrating example communications between a network entity and a UE.

FIG. 7 is a diagram illustrating example processing at a UE or a network entity.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or user equipment.

FIG. 13 is a diagram illustrating an example of a hardware implementation for an example network entity.

### DETAILED DESCRIPTION

In wireless communication, such as in higher frequency bands, a time domain waveform may be used for communication. As an example, a time domain waveform such as a DFT-s-OFDM may be used, which may have good phase noise mitigation with low complexity and a good peak to average power ratio (PAPR) in contrast to an OFDM waveform. In comparison to the OFDM waveform, the time domain waveform may experience channel flatness, e.g., due to an IDFT operation in generating the waveform. The channel flatness may lead to a same error floor across each of the data symbols for a signal transmitted using the time domain waveform. The error floor may reduce the overall spectral efficiency of the wireless communication, as some bandwidths may experience a higher signal to noise ratio (SNR) compared to other bandwidths. Aspects presented herein provide for different bit loading a different modulation and coding scheme (MCS) for the different bandwidths. As presented herein, a DFT/IDFT procedure may be performed for each of multiple bandwidth portions or bandwidth parts Each bandwidth part may be configured with a different MCS fit to the overall signal to interference and noise ratio (SINR) of the particular bandwidth part. The aspects presented herein may improve wireless communication by addressing the different noise or interference at different bandwidths that may affect a time domain waveform, such as DFT-s-OFDM.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

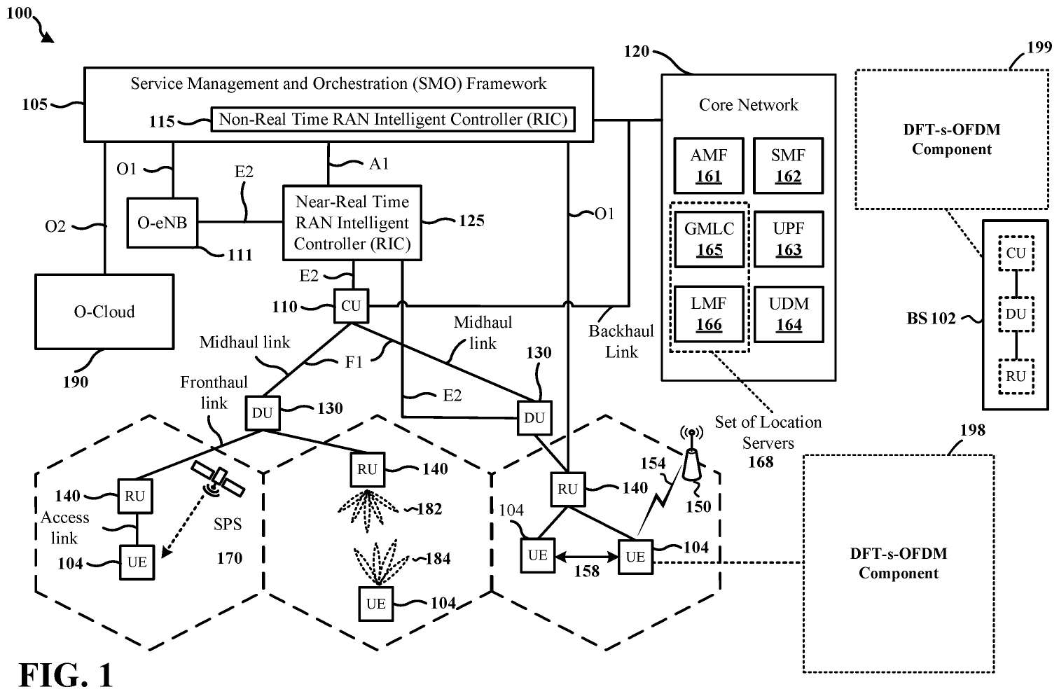

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub—6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a DFT-s-OFDM component 198. In some aspects, the DFT-s-OFDM component 198 may be configured to transmit a capability indication representing a support for multiple discrete Fourier transform (DFT) or multiple inverse discrete Fourier transform (IDFT) for DFT spread orthogonal frequency division multiplexing (DFT-s-OFDM) to a network entity. In some aspects, the DFT-s-OFDM component 198 may be further configured to receive an activation associated with the multiple DFT or the multiple IDFT from the network entity, the activation indicating two or more bandwidth parts (BWPs). In some aspects, the DFT-s-OFDM component 198 may be further configured to transmit or receive a DFT-s-OFDM waveform associated with the multiple DFT or the multiple IDFT in the two or more BWPs with a dedicated DFT or a dedicated IDFT for each BWP of the two or more BWPs.

In certain aspects, the base station 102 may include a DFT-s-OFDM component 199. In some aspects, the DFT-s-OFDM component 199 may be configured to receive, at connection establishment with a UE, a capability indication representing a support for multiple DFT or multiple IDFT for DFT-s-OFDM. In some aspects, the DFT-s-OFDM component 199 may be further configured to transmit an activation associated with the multiple DFT or the multiple IDFT for the UE, the activation indicating two or more BWPs. In some aspects, the DFT-s-OFDM component 199 may be further configured to transmit or receive a DFT-s-OFDM waveform associated with a dedicated DFT or a dedicated IDFT in each of the two or more BWPs.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

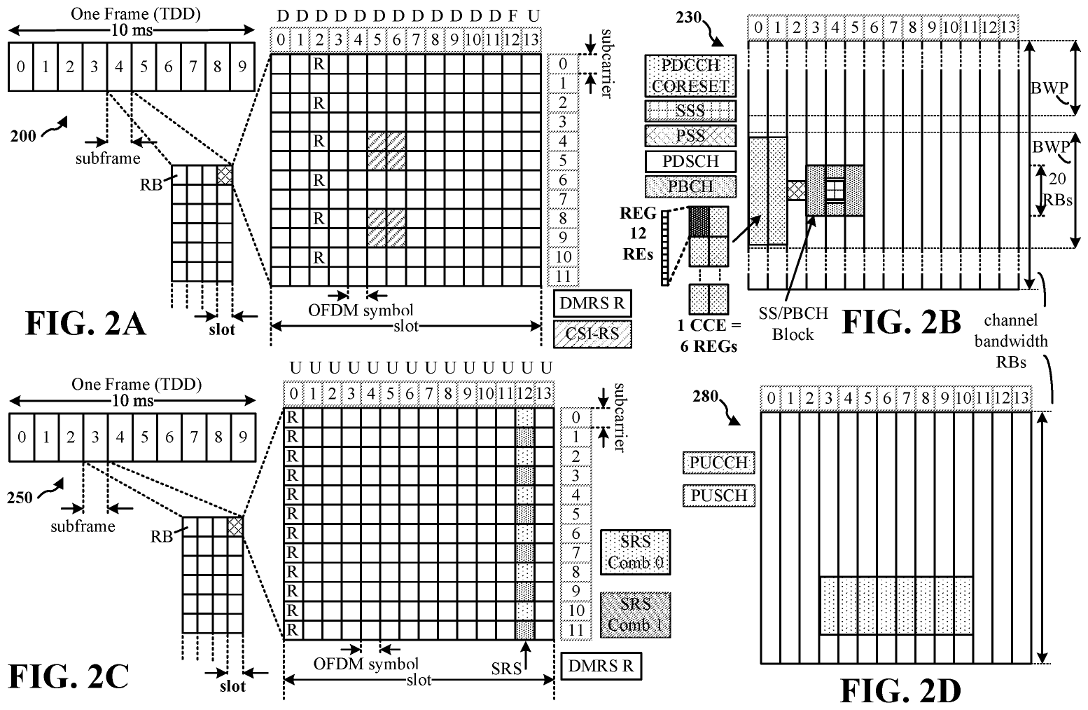

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

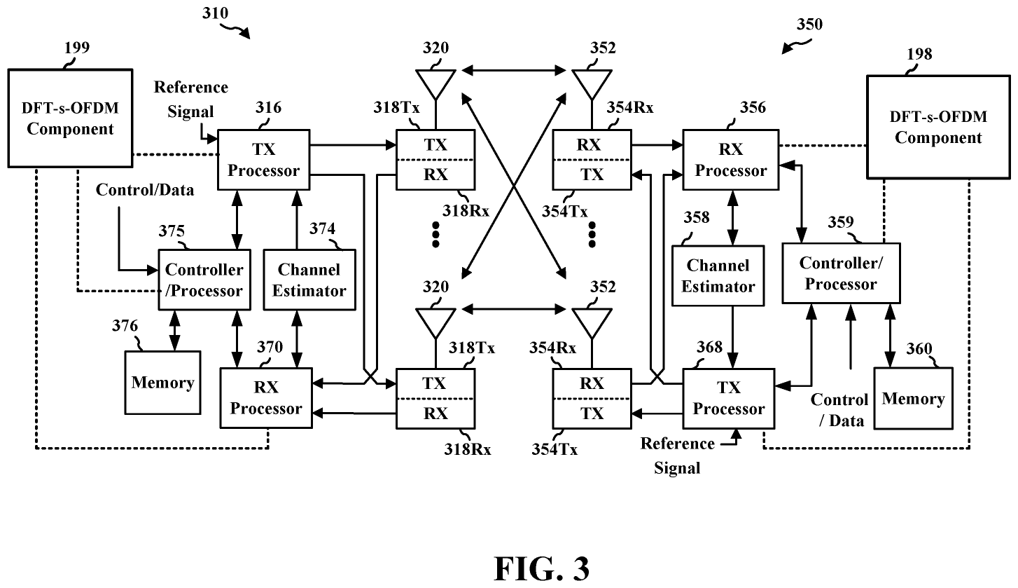

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with DFT-s-OFDM component 198 of FIG. 1.

At least one of the TX processor 316, the RX processor 370, and the controller/processor 375 may be configured to perform aspects in connection with DFT-s-OFDM component 199 of FIG. 1.

To increase the throughput of wireless communication systems, the supported bandwidth of wireless communication systems may be increased. For example, some wireless communication systems may support communication in higher bands (such as the sub-Terahertz (THz) band). To get better phase noise (PN) mitigation without introducing too much processing complexity at the network entities, time domain waveforms, such as DFT-s-OFDM, may be used at such high frequency bands. In DFT-s-OFDM and unlike some other OFDM-based waveforms (e.g., OFDM and cyclic prefix OFDM (CP-OFDM)), the channel frequency flatness may cause a same error floor to be experienced on each the data symbols of such a waveform due to an IDFT operation. The error floor may reduce the overall spectral efficiency as some of the bandwidth may experience higher signal to noise ratio (SNR) (e.g., by 10 dB) compared to other parts of the bandwidth. In a DFT-s-OFDM waveform, the data symbols may be first spread with a DFT block, and then mapped to the input of an IDFT block. As an example, an OFDM waveform may not employ a DFT-spread block and symbols may be mapped to the subcarriers directly. As an example, RSs may be distributed in frequency for OFDM. As an example, RSs may be multiplexed in time for DFT-s-OFDM. In some aspects, DFT-s-OFDM may be a single-carrier waveform and may be referred to as a single carrier FDM (SCFDM) waveform. In some wireless communication systems, quadrature amplitude modulation (QAM) with order 4, 16, 64, or 256 may be used for DFT-s-OFDM. As an example, a transmitter using DFT-s-OFDM may modulate all subcarriers with the same data.

Unlike some other OFDM-based waveforms (e.g., OFDM and CP-OFDM), bit loading or per sub-band MCS may not be obtained in some aspects of a DFT-s-OFDM waveform as the samples may be mapped in the time domain meaning that each time domain (TD) symbol may be carried over the full bandwidth. Aspects provided herein may provide better throughput by adapting the code rate or constellation to multiple BWPs. For example, in some aspects, a bandwidth (BW) may be divided to 4 allocations, each with a different MCS. In some wireless communication systems, to divide the BW into allocations with different MCS, multiple component carrier (CCs) may be included where each component holds a different MCS. Such component carrier based division of BW may introduce carrier overhead for each CC (e.g., guard bands to be provided between the CCs). As the component carriers may be defined rather than adaptive and may be identical to all layers, which may be inflexible. Some aspects provided herein may provide a mechanism where a BW is divided into BWPs, where each BWP may have its own dedicated DFT/IDFT and its own MCS, while maintaining the BWs within one CC. The maintenance of the BWs within the single CC reduces carrier overhead and allows for a dynamic configuration per layer while achieving higher throughput. Some aspects provided herein may provide a multiple DFT or IDFT in the processing of DFT-s-OFDM waveform for enabling different MCS per BWP and which may improve the overall throughput. In some aspects, multiple DFT or multiple IDFT may be employed to generate a DFT-s-OFDM waveform that allows for adaptive MCS per BWP.

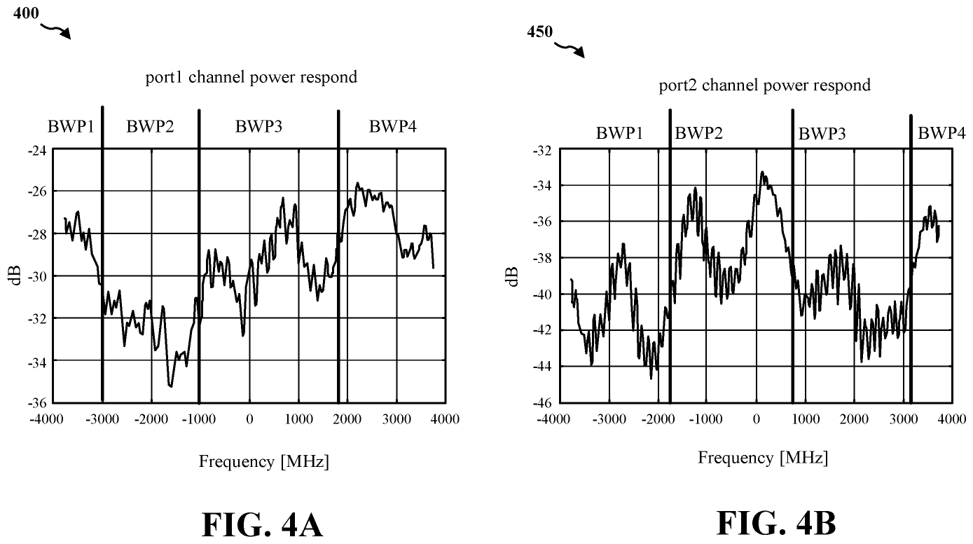

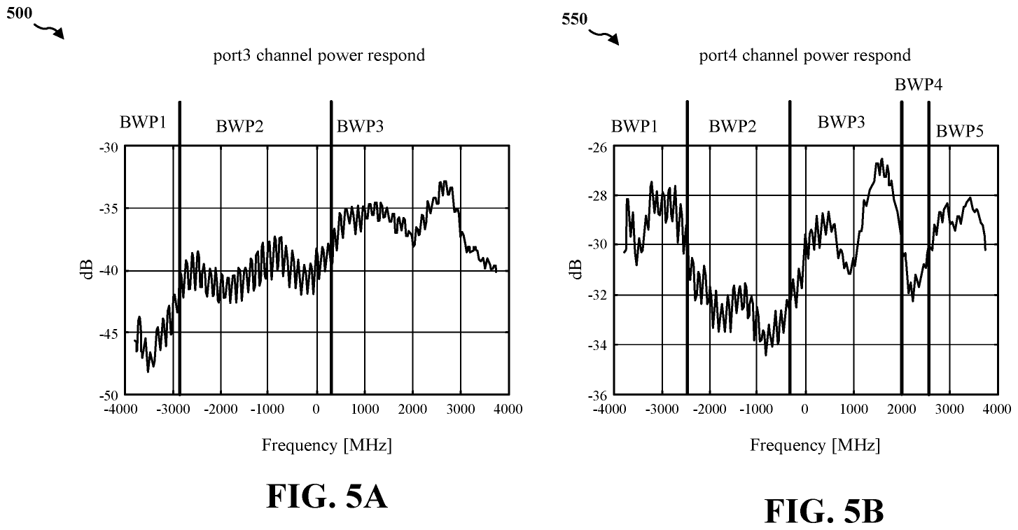

As an example, FIGS. 4A and 4B are diagrams 400 and 450 illustrating example channel frequency domain response for port 1 and port 2 of a 4 port wireless transmission. FIGS. 5A and 5B are diagrams 500 and 550 illustrating an example channel frequency domain response for port 3 and 4 of the 4 ports. The channel frequency domain response shown in FIGS. 4A and 4B and FIGS. 5A and 5B may be over a 30 meters link with four streams transmitted over a line-of-sight (LOS) MIMO link, for example. FIG. 4A may illustrate a first stream of the four streams, FIG. 4B may illustrate a second stream of the four streams, FIG. 5A may illustrate a third stream of the four streams, and FIG. 5B may illustrate a fourth stream of the four streams.

As illustrated in FIG. 4A, the BW for port 1 in diagram 400 may be divided into four BWPs including BWP #1, BWP #2, BWP #3, and BWP #4. As illustrated in FIG. 4B, the BW for port 2 in diagram 450 may be divided into four BWPs including BWP #1, BWP #2, BWP #3, and BWP #4. As illustrated in FIG. 5A, the BW for port 3 in diagram 500 may be divided into three BWPs including BWP #1, BWP #2, and BWP #3. As illustrated in FIG. 5B, the BW for port 4 in diagram 550 may be divided into five BWPs including BWP #1, BWP #2, BWP #3, BWP #4, and BWP #5. As illustrated in FIGS. 4A and 4B and FIGS. 5A and 5B, the number of BWPs may not identical be per stream. For example, the BW may be divided into four BWPs for stream #1 and stream #2, divided into three BWPs for stream #3, and divided into five BWPs for stream #4.

In some aspects, the number of BWPs may be configured dynamically based on the channel conditions per stream. Each BWP may be configured with different MCS that may be fit to its BWP overall signal to interference and noise ratio (SINR). A receiving end (such as a UE or a base station) may provide feedback to the transmitting end (such as base station or a UE) of the BWP number that the receiving end it may want to use (e.g., desired BWP number) and separation frequencies (e.g., which is associated with the boundaries of the BWPs). In some aspects, channel quality indicator (CQI) report per BWP may be provided from the receiving end to the transmitting end.

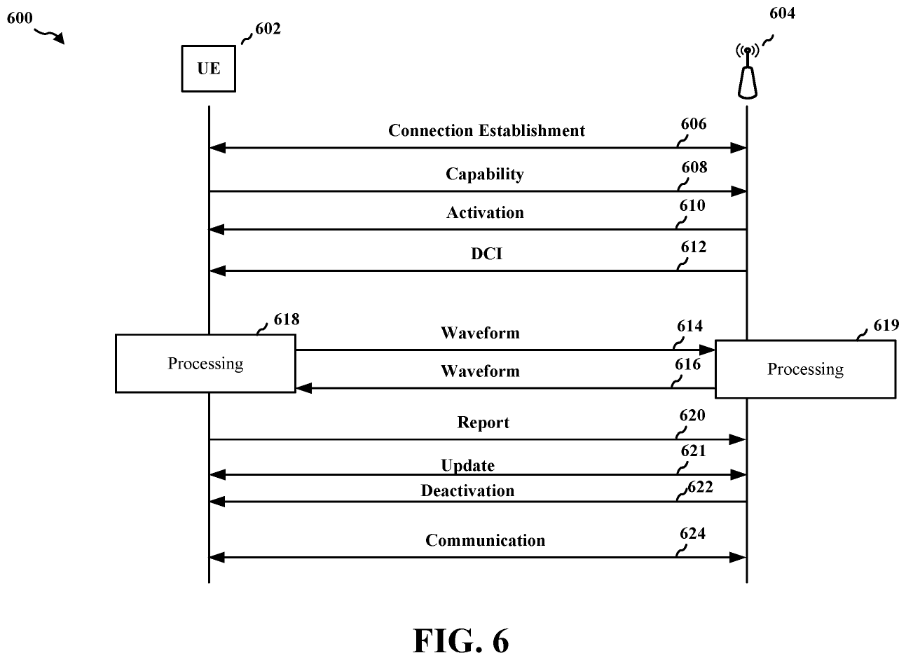

FIG. 6 is a diagram 600 illustrating example communications between a network entity 604 and a UE 602. In some aspects, the network entity 604 may be referred to as a network node. In some aspects, the network node may be implemented as an aggregated base station, a component of a disaggregated base station, an integrated access and backhaul (IAB) node, a relay node, a sidelink node, or the like. In some aspects, the network entity 604 may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 6, the UE 602 and the network entity 604 may establish a connection, as shown at connection establishment 606. Upon the connection establishment 606, and/or at another point, the UE 602 may transmit capability information (e.g., capability 608) to the network entity 604 indicating the UE 602's support for a capability such as for multiple DFT/IDFT in DFT-s-OFDM. In some aspects, the capability information, e.g., 608, may include a report or indication of a number of BWPs that may be supported simultaneously by the UE 602 (such as 4 BWPs for downlink or uplink). Four is merely an example to illustrate the concept, the UE may indicate a capability for 2 DL BWPs, 3 DL BWPs, 2 UL BWPs, 3 UL BWPs, etc. In some aspects, the capability 608 may include a report of recommended UL/DL BWP frequency locations (frequency locations of UL/DL BWPs that the UE 602 may prioritize using) based on the operating band of the UE 602. In some aspects, the recommended UL/DL BWP frequency locations may be based on a configuration at the UE 602 without signaling (e.g., such as based on a factory calibration) or an estimated CSI-RS or DMRS pilot.

In some aspects, upon receiving the capability 608, the network entity 604 may transmit an activation 610 to the UE 602. The activation 610 may indicate to the UE whether multiple DFT/IDFT for multiple BWPs is activated. The activation 610 may also indicate multiple BWPs and the locations of each of the BWPs. For example, the network entity 604 may include, in the activation 610, an indication indicating RB #6 and RB #33 (which may be BWP boundaries within the BW), which may represent that BWP #1 is from RB #1 to RB #6, BWP #2 is from RB #7 to RB #33, and BWP #3 is from RB #34 to the end of the allocation of the BW. Each BWP in the BW may have a dedicated DFT according to the BWP's size which may be the input for the IFFT for a time domain waveform generation. In some aspects, the network entity 604 may indicate to the UE 602, such as in the activation 610, if the BWP is the same for all layers or different per stream. In some aspects, the network entity 604 may indicate to the UE 602, such as in the activation 610, whether a same BWP may be used for UL/DL transmission(s). In some aspects, each of the multiple BWPs associated with the activation 610 may be associated with an MCS. For example, each of the multiple BWPs associated with the activation 610 may be associated with a different MCS. For example, a first MCS may be associated with BWP #1, a second MCS may be associated with BWP #2, and a third MCS may be associated with BWP #3. In some aspects, one or more of the first MCS, the second MCS, or the third MCS may be different from each other. In some aspects, one or more of the first MCS, the second MCS, or the third MCS may also be identical with each other.

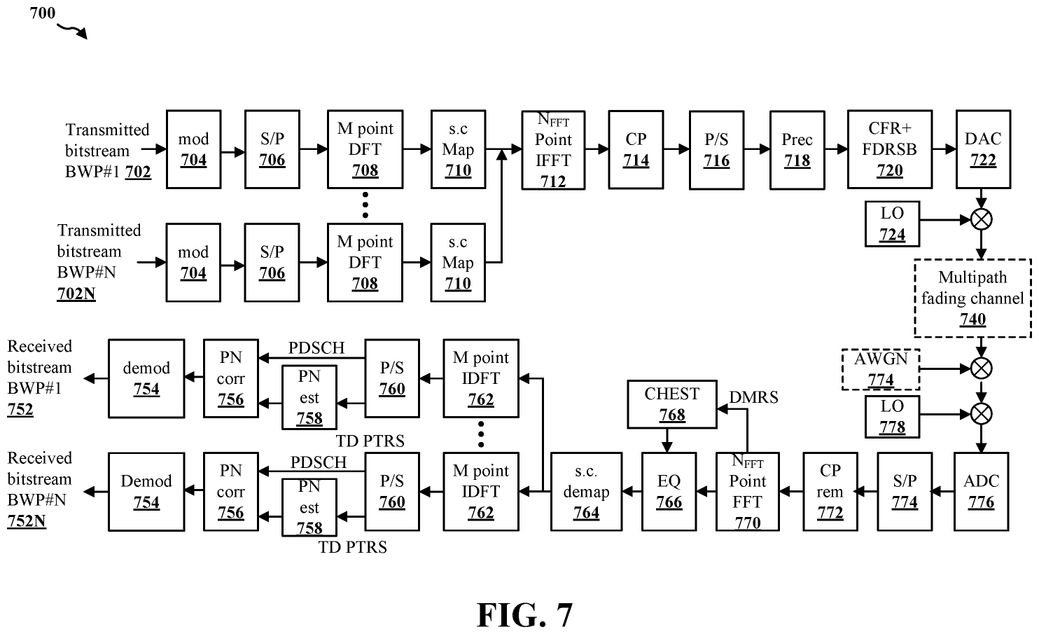

In some aspects, the network entity 604 may transmit a DCI 612 to the UE 602. In some aspects, the DCI 612 may schedule downlink transmissions from the network entity 604 to the UE 602. In some aspects, the network entity 604 may transmit downlink data in waveform 616 to the UE 602. In some aspects, the waveform 616 may be transmitted in each of the BWPs associated with (e.g., indicated by) the activation 610. In some aspects, the waveform 616 may be DFT-s-OFDM waveform in each of the BWPs associated with (e.g., indicated by) the activation 610. Upon receiving the waveform 616, the UE 602 may perform processing accordingly at 618. The processing at 618 may be further elaborated in connection with FIG. 7. In some aspects, as part of 618, the UE 602 may perform a different IDFT for each of the BWPs associated with the waveform 616.

Similarly, in some aspects, the UE 602 may transmit uplink data in waveform 614 to the network entity 604. In some aspects, the waveform 614 may be transmitted in each of the BWPs indicated by the activation 610. In some aspects, the waveform 614 may be DFT-s-OFDM waveform in each of the BWPs associated with (e.g., indicated by) the activation 610. To transmit the waveform 614, the UE 602 may perform processing accordingly at 618. The processing at 618 may be further elaborated in connection with FIG. 7. In some aspects, as part of 618, the UE 602 may perform a different DFT for each of the BWPs associated with the waveform 614. In such aspects, the base station may perform the processing, at 619, to receive the DFT-s-OFDM waveform, such as described above in connection with processing 618.

In some aspects, the UE 602 may transmit a report 620 to the network entity 604. In some aspects, the report 620 may be a CQI, pre-coding matrix indicator (PMI), or a rank indicator (RI). In some aspects, a CQI, PMI, or RI may be associated with one BWP of the multiple BWPs. For example, a different CQI, PMI, or RI may be transmitted for each BWP indicated by the activation 610 and used for carrying the waveform 614 or the waveform 616. In some aspects, the report 620 may represent a channel condition associated with each of the BWP. The network entity 604 may transmit CSI-RS pilots on the full BW (including all BWPs indicated in the activation 610) so that the UE 602 may update its BWP recommendation in the update 621. In some aspects, the network entity 604 may accordingly update the BWP to be used in the update 621.

In some aspects, the network entity 604 may transmit a deactivation 622 indicating deactivation of multiple DFT/IDFT for communications between the UE 602 and the network entity 604. For example, the network entity 604 may transmit the deactivation 622 based on the UE 602 being in coverage conditions (e.g., where peak-to-average-power ratio may be more important than the BWP). After the UE 602 receives the deactivation 622, the UE 602 and the network entity 604 may communication with each other (e.g., by exchanging communication 624) without multiple DFT/IDFT or multiple BWPs, e.g., using a single BWP and a single DFT/IDFT. For example, the communication 624 may be exchanged based on DFT-s-OFDM waveform on one BWP and a single TB.

FIG. 7 is a diagram 700 illustrating example processing at a UE, such as the UE 602 or at a network entity, such as the network entity 604. For example, the processing to transmit the bitstream in a DFT-s-OFDM waveform may be performed by a UE as a transmitter or by a network entity such as a base station or a component of a base station as a transmitter. Similarly, the receive processing may be performed by a base station or a component of a base station that is receiving a DFT-s-OFDM waveform or by a UE that is receiving a DFT-s-OFDM waveform. As illustrated in FIG. 7, to transmit a bitstream on BWP #1 702 and BWP #N 702N on BWP #N (N being any positive integer not 1). The UE or the network entity may first modulate the bitstream on BWP 702 and BWP 702N at modulation 704. After modulating the bitstream on BWP 702 and BWP 702N at modulation 704, an output of the modulation 704 may be used by the UE or the network entity as an input for serial to parallel 706. After performing the serial to parallel 706, the UE may perform M-point DFT 708 for the bitstream (which may include different parts associated with different BWPs). In other words, each DFT of the M-point DFT 708 may be associated with a different BWP and performed for a different DFT.

In some aspects, after performing the M-point DFT 708, an output of the M-point DFT 708 may be used by the UE or the network entity as an input for subcarrier mapping 710. In some aspects, after performing the subcarrier mapping 710, an output of the subcarrier mapping 710 may be used by the UE or the network entity as an input for IFFT 712. In some aspects, after performing the IFFT 712, an output of the IFFT 712 may be used by the UE or the network entity as an input for cyclic prefix 714. In some aspects, after performing the cyclic prefix 714, an output of the cyclic prefix 714 may be used by the UE or the network entity as an input for parallel to serial 716.

In some aspects, after performing the parallel to serial 716, an output of the parallel to serial 716 may be used by the UE or the network entity as an input for precoding 718. In some aspects, after performing the precoding 718, an output of the precoding 718 may be used by the UE or the network entity as an input for crest factor reduction (CFR) and FDRSB 720.

In some aspects, after performing the CFR and FDRSB 720, an output of the CFR and FDRSB 720 may be used by the UE or the network entity as an input for digital to analog conversion 722. After adding lo gain 724 to the output of the digital to analog conversion 722, the output of the digital to analog conversion 722 (which may be a DFT-s-OFDM waveform) may be transmitted (e.g., as waveform 614) on a multipath fading channel 740.

As illustrated in FIG. 7, upon receiving a DFT-s-OFDM waveform in the multipath fading channel 740, a receiver such as a UE or a network entity (e.g., a base station or a component of a base station) may apply Additive white Gaussian noise (AWGN) 774 to the DFT-s-OFDM waveform and apply a lo gain 778 after applying the AWGN 774. Then the UE or the network entity may perform analog to digital conversion 776. In some aspects, after performing the analog to digital conversion 776, an output of the analog to digital conversion 776 may be used by the UE or the network entity as an input for serial to parallel 774.

In some aspects, after performing the serial to parallel 774, an output of the serial to parallel 774 may be used by the UE or the network entity as an input for cyclic prefix removal 772.

In some aspects, after performing the cyclic prefix removal 772, an output of the cyclic prefix removal 772 may be used by the UE or the network entity as an input for N point FFT 770. In some aspects, after the N point FFT 770, an output of the N point FFT 770 may be used by the UE or the network entity as an input for channel estimation 768 based on DM-RS. In some aspects, an output of the N point FFT 770 and an output of the channel estimation 768 based on DM-RS may be used by the UE or the network entity as an input for equalization 766.

In some aspects, an output of the equalization 766 may be used by the UE or the network entity as an input for subcarrier de-mapping 764. In some aspects, after performing the subcarrier de-mapping 764, an output of the subcarrier de-mapping 764 may be used by the UE or the network entity as an input for M-point IDFT 762. In some aspects, the UE may perform M-point IDFT 762 including an IDFT for each different BWP associated with the received waveform. In other words, each IDFT of the M-point IDFT 762 may be associated with a different BWP of the received waveform and performed for a different BWP of the received waveform.

In some aspects, after performing the M-point IDFT 762, an output of the M-point IDFT 762 may be used by the UE or the network entity as an input for parallel to serial 760. In some aspects, after performing the parallel to serial 760, an output of the parallel to serial 760 may be used as an input for phase noise estimation 758.

In some aspects, after performing the phase noise estimation 758, an output of the phase noise estimation 758 may be used by the UE or the network entity as an input for phase noise correction 756 based on PDSCH. In some aspects, after performing the phase noise correction 756, an output of the phase noise correction 756 may be used by the UE or the network entity as an input for demodulation 754 to receive bitstream, which may include different parts on different BWPs, including BWP #1 752 and BWP #N 752N.

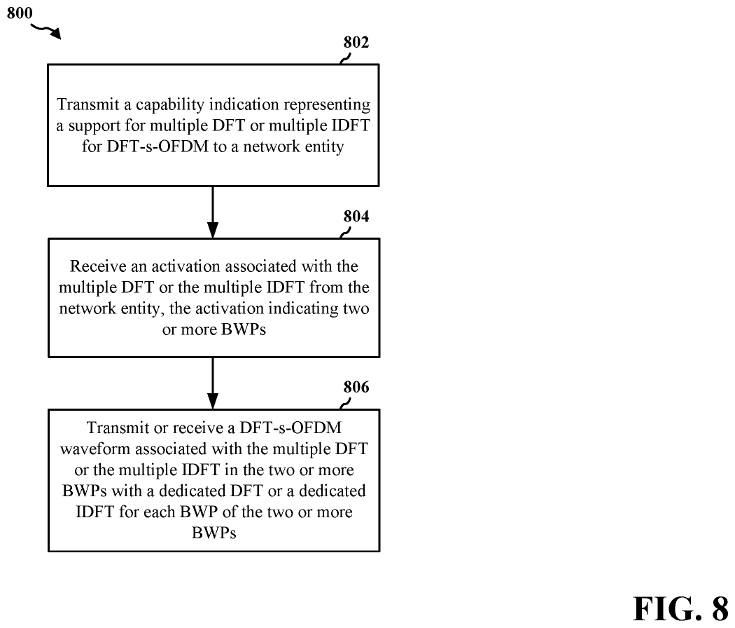

FIG. 8 is a flowchart 800 of a method of wireless communication. The method may be performed by a UE (e.g., the UE 104, the UE 602; the apparatus 1204).

At 802, the UE may transmit a capability indication representing a support for multiple DFT or multiple IDFT for DFT-s-OFDM to a network entity. For example, the UE 602 may transmit a capability indication (e.g., capability 608) representing a support for multiple DFT or multiple IDFT for DFT-s-OFDM to a network entity 604. In some aspects, 802 may be performed by the DFT-s-OFDM component 198.

At 804, the UE may receive an activation associated with the multiple DFT or the multiple IDFT from the network entity, the activation indicating two or more BWPs. For example, the UE 602 may receive an activation 610 associated with the multiple DFT or the multiple IDFT from the network entity 604, the activation indicating two or more BWPs. In some aspects, 804 may be performed by the DFT-s-OFDM component 198.

At 806, the UE may transmit or receive a DFT-s-OFDM waveform associated with the multiple DFT or the multiple IDFT in the two or more BWPs with a dedicated DFT or a dedicated IDFT for each BWP of the two or more BWPs. For example, the UE 602 may transmit or receive a DFT-s-OFDM waveform (e.g., waveform 614 or waveform 616) associated with the multiple DFT or the multiple IDFT in the two or more BWPs with a dedicated DFT or a dedicated IDFT for each BWP of the two or more BWPs. In some aspects, 806 may be performed by the DFT-s-OFDM component 198.

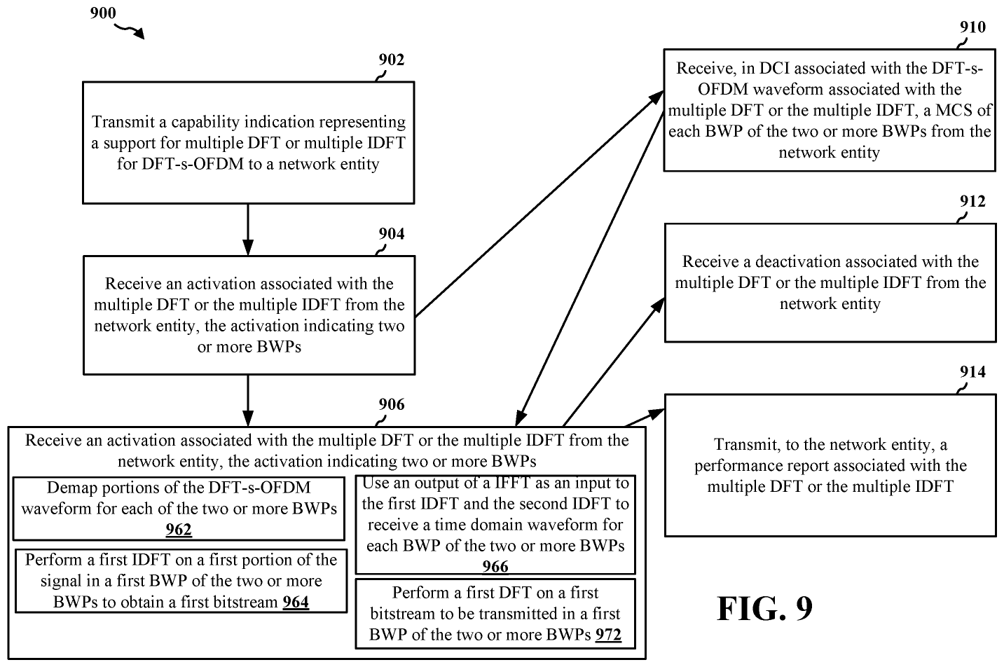

FIG. 9 is a flowchart 900 of a method of wireless communication. The method may be performed by a UE (e.g., the UE 104, the UE 602; the apparatus 1204).

At 902, the UE may transmit a capability indication representing a support for multiple DFT or multiple IDFT for DFT-s-OFDM to a network entity. For example, the UE 602 may transmit a capability indication (e.g., capability 608) representing a support for multiple DFT or multiple IDFT for DFT-s-OFDM to a network entity 604. In some aspects, 902 may be performed by the DFT-s-OFDM component 198. In some aspects, the capability indication further includes a number of simultaneous BWPs supported by the UE, and the number of simultaneous BWPs supported by the UE is equal to a number of the multiple DFT or the multiple IDFT. In some aspects, the capability indication is further associated with one or more frequency locations associated with one or more BWPs associated with the number of simultaneous BWPs. In some aspects, the one or more frequency locations are based on one or more channel state information reference signals (CSI-RS) or one or more demodulation reference signals (DM-RS).

At 904, the UE may receive an activation associated with the multiple DFT or the multiple IDFT from the network entity, the activation indicating two or more BWPs. For example, the UE 602 may receive an activation 610 associated with the multiple DFT or the multiple IDFT from the network entity 604, the activation indicating two or more BWPs. In some aspects, 904 may be performed by the DFT-s-OFDM component 198. In some aspects, the activation further indicates a set of locations associated with the two or more BWPs. In some aspects, the two or more BWPs are associated with a same layer or different layers.

At 906, the UE may transmit or receive a DFT-s-OFDM waveform associated with the multiple DFT or the multiple IDFT in the two or more BWPs with a dedicated DFT or a dedicated IDFT for each BWP of the two or more BWPs. For example, the UE 602 may transmit or receive a DFT-s-OFDM waveform (e.g., waveform 614 or waveform 616) associated with the multiple DFT or the multiple IDFT in the two or more BWPs with a dedicated DFT or a dedicated IDFT for each BWP of the two or more BWPs. In some aspects, 906 may be performed by the DFT-s-OFDM component 198. In some aspects, the UE may receive the DFT-s-OFDM waveform associated with the multiple IDFT in each BWP of the two or more BWPs, and the UE may demap portions of the DFT-s-OFDM waveform for each of the two or more BWPs at 962, perform a first IDFT on a first portion of the signal in a first BWP of the two or more BWPs to obtain a first bitstream at 964, and perform a second IDFT on a second portion of the signal in a second BWP of the two or more BWPs to obtain a second bitstream. In some aspects, the UE may also use an output of a fast Fourier transform (FFT) as an input to the first IDFT and the second IDFT to receive a time domain waveform for each BWP of the two or more BWPs at 966.

In some aspects, the UE may transmit the DFT-s-OFDM waveform associated with the multiple DFT in each BWP of the two or more BWPs, and the UE may perform a first DFT on a first bitstream to be transmitted in a first BWP of the two or more BWPs (e.g., at 972) and perform a second DFT on a second bitstream to be transmitted in a second BWP of the two or more BWPs. In some aspects, the UE may use an output of the first DFT and the second DFT as an input for an inverse fast Fourier transform (IFFT) to transmit a time domain waveform for each BWP of the two or more BWPs.

At 914, the UE may transmit a channel quality indicator (CQI), a pre-coding matrix indicator (PMI), or a rank indicator (RI) associated with each BWP of the two or more BWPs to the network entity. For example, the UE 602 may transmit a channel quality indicator (CQI), a pre-coding matrix indicator (PMI), or a rank indicator (RI) associated with each BWP of the two or more BWPs to the network entity 604. In some aspects, 914 may be performed by the DFT-s-OFDM component 198. In some aspects, the UE may receive channel state information reference signals (CSI-RS) from the network entity based on the CQI, the PMI, or the RI associated with each BWP of the two or more BWPs. In some aspects, 914 may be performed by the DFT-s-OFDM component 198.

At 910, the UE may receive, in downlink control information (DCI) associated with the DFT-s-OFDM waveform associated with the multiple DFT or the multiple IDFT, a modulation and coding scheme (MCS) of each BWP of the two or more BWPs from the network entity. For example, the UE may receive, in DCI 612 associated with the DFT-s-OFDM waveform associated with the multiple DFT or the multiple IDFT, a modulation and coding scheme (MCS) of each BWP of the two or more BWPs from the network entity 604. In some aspects, 910 may be performed by the DFT-s-OFDM component 198. In some aspects, the DCI includes multiple DCI associated with multiple CCs associated with the two or more BWPs.

In some aspects, at 912, the UE may receive a deactivation associated with the multiple DFT or the multiple IDFT from the network entity, where the deactivation further indicates one BWP. For example, the UE 602 may receive, from the network entity 604, a deactivation 622. In some aspects, 912 may be performed by the DFT-s-OFDM component 198. In some aspects, the UE may receive or transmit a second DFT-s-ODFM waveform associated with the one BWP from the network entity. In some aspects, the UE may transmit, to the network entity, a performance report (e.g., in report 620) associated with the multiple DFT or the multiple IDFT.

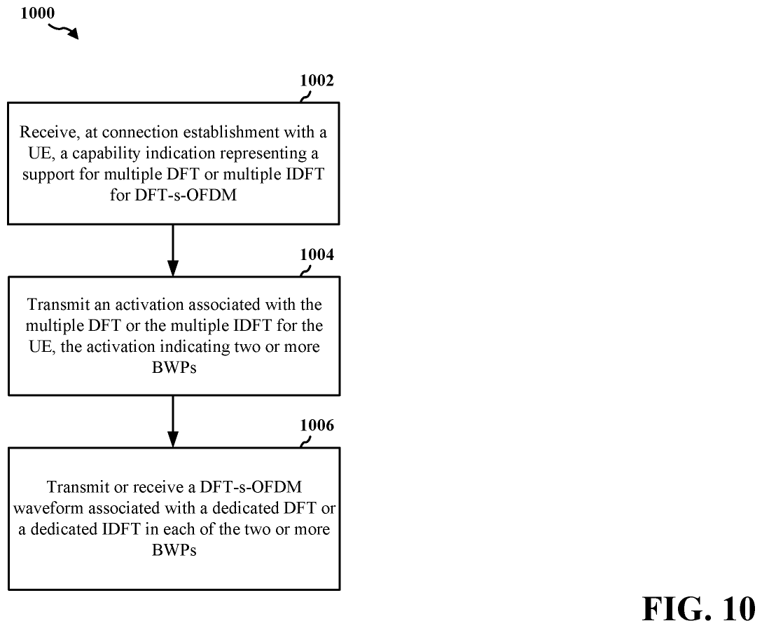

FIG. 10 is a flowchart 1000 of a method of wireless communication. The method may be performed by a network entity (e.g., the base station 102, the network entity 604 the network entity 1202, the network entity 1302).

At 1002, the network entity may receive a capability indication representing a support for multiple DFT or multiple IDFT for DFT-s-OFDM for a UE. For example, the network entity 604 may receive a capability indication (e.g., capability 608) representing a support for multiple DFT or multiple IDFT for DFT-s-OFDM for a UE 602. In some aspects, 1002 may be performed by the DFT-s-OFDM component 199.

At 1004, the network entity may transmit an activation associated with the multiple DFT or the multiple IDFT for the UE, the activation indicating two or more BWPs. For example, the network entity 604 may transmit an activation 610 associated with the multiple DFT or the multiple IDFT to the UE 602, the activation indicating two or more BWPs. In some aspects, 1004 may be performed by the DFT-s-OFDM component 199.

At 1006, the network entity may receive or transmit a DFT-s-OFDM waveform associated with the multiple DFT or the multiple IDFT in the two or more BWPs with a dedicated DFT or a dedicated IDFT for each BWP of the two or more BWPs. For example, the network entity 604 may receive or transmit a DFT-s-OFDM waveform (e.g., waveform 614 or waveform 616) associated with the multiple DFT or the multiple IDFT in the two or more BWPs with a dedicated DFT or a dedicated IDFT for each BWP of the two or more BWPs. In some aspects, 1006 may be performed by the DFT-s-OFDM component 199.

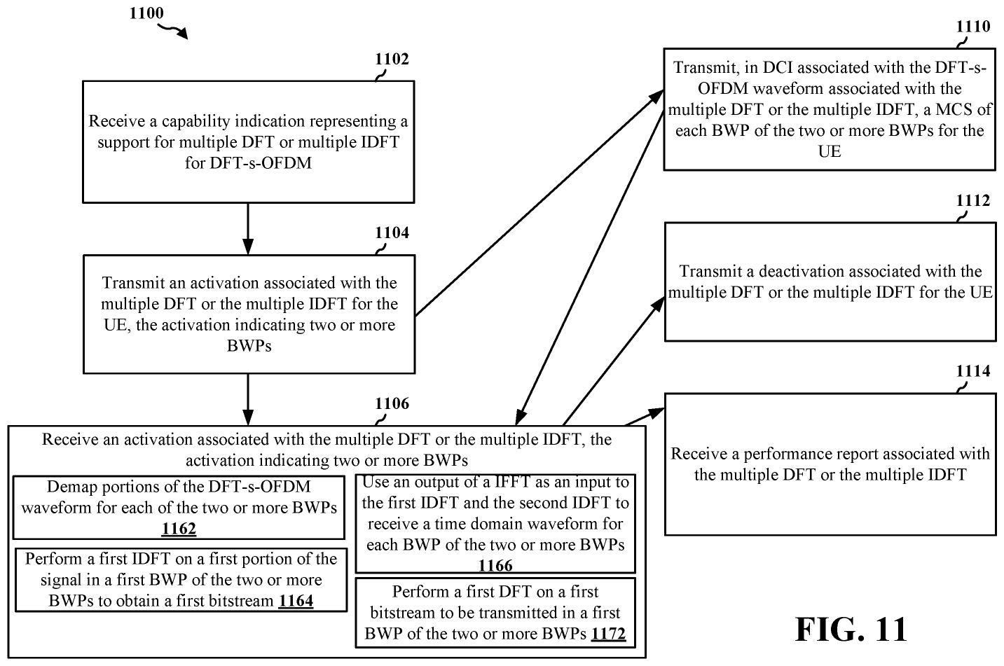

FIG. 11 is a flowchart 1100 of a method of wireless communication. The method may be performed by a network entity (e.g., the base station 102, the network entity 604 the network entity 1202, the network entity 1302).

At 1102, the network entity may receive a capability indication representing a support for multiple DFT or multiple IDFT for DFT-s-OFDM for a UE. For example, the network entity 604 may receive a capability indication (e.g., capability 608) representing a support for multiple DFT or multiple IDFT for DFT-s-OFDM for a UE 602. In some aspects, 1102 may be performed by the DFT-s-OFDM component 199. In some aspects, the capability indication further includes a number of simultaneous BWPs supported by the UE, and the number of simultaneous BWPs supported by the UE is equal to a number of the multiple DFT or the multiple IDFT. In some aspects, the capability indication is further associated with one or more frequency locations associated with one or more BWPs associated with the number of simultaneous BWPs. In some aspects, the one or more frequency locations are based on one or more channel state information reference signals (CSI-RS) or one or more demodulation reference signals (DM-RS).

At 1104, the network entity may transmit an activation associated with the multiple DFT or the multiple IDFT, the activation indicating two or more BWPs. For example, the network entity 604 may transmit an activation 610 associated with the multiple DFT or the multiple IDFT to the UE 602, the activation indicating two or more BWPs. In some aspects, 1104 may be performed by the DFT-s-OFDM component 199. In some aspects, the activation further indicates a set of locations associated with the two or more BWPs. In some aspects, the two or more BWPs are associated with a same layer or different layers.

At 1106, the network entity may receive or transmit a DFT-s-OFDM waveform associated with the multiple DFT or the multiple IDFT in the two or more BWPs with a dedicated DFT or a dedicated IDFT for each BWP of the two or more BWPs. For example, the network entity 604 may receive or transmit a DFT-s-OFDM waveform (e.g., waveform 614 or waveform 616) associated with the multiple DFT or the multiple IDFT in the two or more BWPs with a dedicated DFT or a dedicated IDFT for each BWP of the two or more BWPs. In some aspects, 1106 may be performed by the DFT-s-OFDM component 199. In some aspects, the network entity may transmit the DFT-s-OFDM waveform associated with the multiple IDFT in each BWP of the two or more BWPs, and the UE may demap portions of the DFT-s-OFDM waveform for each of the two or more BWPs at 1162, perform a first IDFT on a first portion of the signal in a first BWP of the two or more BWPs to obtain a first bitstream at 1164, and perform a second IDFT on a second portion of the signal in a second BWP of the two or more BWPs to obtain a second bitstream. In some aspects, the UE may also use an output of a fast Fourier transform (FFT) as an input to the first IDFT and the second IDFT to receive a time domain waveform for each BWP of the two or more BWPs at 1166.

In some aspects, the network entity may receive the DFT-s-OFDM waveform associated with the multiple DFT in each BWP of the two or more BWPs, and the UE may perform a first DFT (e.g., at 1172) on a first bitstream to be transmitted in a first BWP of the two or more BWPs and perform a second DFT on a second bitstream to be transmitted in a second BWP of the two or more BWPs. In some aspects, the UE may use an output of the first DFT and the second DFT as an input for an inverse fast Fourier transform (IFFT) to transmit a time domain waveform for each BWP of the two or more BWPs.

At 1114, the network entity may receive a channel quality indicator (CQI), a pre-coding matrix indicator (PMI), or a rank indicator (RI) associated with each BWP of the two or more BWPs for the UE. For example, the network entity 604 may receive a channel quality indicator (CQI), a pre-coding matrix indicator (PMI), or a rank indicator (RI) associated with each BWP of the two or more BWPs for the UE 602. In some aspects, 1114 may be performed by the DFT-s-OFDM component 199. In some aspects, the network entity may transmit channel state information reference signals (CSI-RS) based on the CQI, the PMI, or the RI associated with each BWP of the two or more BWPs. In some aspects, 1114 may be performed by the DFT-s-OFDM component 199.

At 1110, the network entity may transmit, in downlink control information (DCI) associated with the DFT-s-OFDM waveform associated with the multiple DFT or the multiple IDFT, a modulation and coding scheme (MCS) of each BWP of the two or more BWPs. For example, the network entity may transmit, in DCI 612 associated with the DFT-s-OFDM waveform associated with the multiple DFT or the multiple IDFT, a modulation and coding scheme (MCS) of each BWP of the two or more BWPs to the UE 602. In some aspects, 1110 may be performed by the DFT-s-OFDM component 199. In some aspects, the DCI includes multiple DCI associated with multiple CCs associated with the two or more BWPs.

In some aspects, at 1112, the network entity may transmit a deactivation associated with the multiple DFT or the multiple IDFT, where the deactivation further indicates one BWP. For example, the network entity 604 may transmit, to the UE 602, a deactivation 622. In some aspects, 1112 may be performed by the DFT-s-OFDM component 199. In some aspects, the network entity may receive or transmit a second DFT-s-ODFM waveform associated with the one BWP. In some aspects, the network entity may receive, for the UE, a performance report (e.g., in report 620) associated with the multiple DFT or the multiple IDFT.

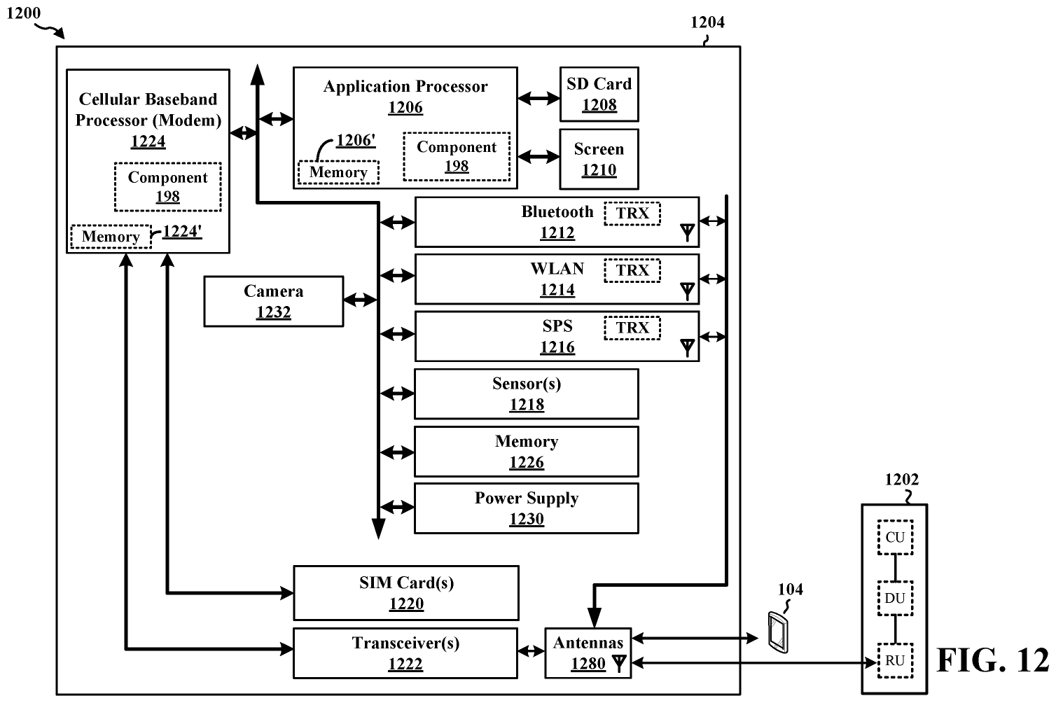

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, a satellite system module 1216 (e.g., GNSS module), one or more sensor modules 1218 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the satellite system module 1216 may include an on-chip transceiver (TRX)/receiver (RX). The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described herein. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed herein, the DFT-s-OFDM component 198 may be configured to transmit a capability indication representing a support for multiple discrete Fourier transform (DFT) or multiple inverse discrete Fourier transform (IDFT) for DFT spread orthogonal frequency division multiplexing (DFT-s-OFDM) to a network entity. In some aspects, the DFT-s-OFDM component 198 may be further configured to receive an activation associated with the multiple DFT or the multiple IDFT from the network entity, the activation indicating two or more bandwidth parts (BWPs). In some aspects, the DFT-s-OFDM component 198 may be further configured to transmit or receive a DFT-s-OFDM waveform associated with the multiple DFT or the multiple IDFT in the two or more BWPs with a dedicated DFT or a dedicated IDFT for each BWP of the two or more BWPs. The DFT-s-OFDM component 198 may be within the cellular baseband processor 1224, the application processor 1206, or both the cellular baseband processor 1224 and the application processor 1206. The DFT-s-OFDM component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for transmitting a capability indication representing a support for multiple DFT or multiple IDFT for DFT-s-OFDM to a network entity. In some aspects, the apparatus 1204 may further include means for receiving an activation associated with the multiple DFT or the multiple IDFT from the network entity, the activation indicating two or more BWPs. In some aspects, the apparatus 1204 may further include means for transmitting or receiving a DFT-s-OFDM waveform associated with the multiple DFT or the multiple IDFT in the two or more BWPs with a dedicated DFT or a dedicated IDFT for each BWP of the two or more BWPs. In some aspects, the apparatus 1204 may further include means for demapping portions of the DFT-s-OFDM waveform for each of the two or more BWPs. In some aspects, the apparatus 1204 may further include means for performing a first IDFT on a first portion of the signal in a first BWP of the two or more BWPs to obtain a first bitstream. In some aspects, the apparatus 1204 may further include means for performing a second IDFT on a second portion of the signal in a second BWP of the two or more BWPs to obtain a second bitstream. In some aspects, the apparatus 1204 may further include means for use an output of a fast Fourier transform (FFT) as an input to the first IDFT and the second IDFT to receive a time domain waveform for each BWP of the two or more BWPs. In some aspects, the apparatus 1204 may further include means for perform a first DFT on a first bitstream to be transmitted in a first BWP of the two or more BWPs. In some aspects, the apparatus 1204 may further include means for performing a second DFT on a second bitstream to be transmitted in a second BWP of the two or more BWPs. In some aspects, the apparatus 1204 may further include means for using an output of the first DFT and the second DFT as an input for an inverse fast Fourier transform (IFFT) to transmit a time domain waveform for each BWP of the two or more BWPs. In some aspects, the apparatus 1204 may further include means for transmitting a channel quality indicator (CQI), a pre-coding matrix indicator (PMI), or a rank indicator (RI) associated with each BWP of the two or more BWPs to the network entity. In some aspects, the apparatus 1204 may further include means for receiving channel state information reference signals (CSI-RS) from the network entity based on the CQI, the PMI, or the RI associated with each BWP of the two or more BWPs. In some aspects, the apparatus 1204 may further include means for receiving, in downlink control information (DCI) associated with the DFT-s-OFDM waveform associated with the multiple DFT or the multiple IDFT, a modulation and coding scheme (MCS) of each BWP of the two or more BWPs from the network entity. In some aspects, the apparatus 1204 may further include means for receiving a deactivation associated with the multiple DFT or the multiple IDFT from the network entity, where the deactivation further indicates one BWP. In some aspects, the apparatus 1204 may further include means for receiving a second DFT-s-ODFM waveform associated with the one BWP from the network entity. In some aspects, the apparatus 1204 may further include means for transmitting, to the network entity, a performance report associated with the multiple DFT or the multiple IDFT. The means may be the DFT-s-OFDM component 198 of the apparatus 1204 configured to perform the functions recited by the means. As described herein, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

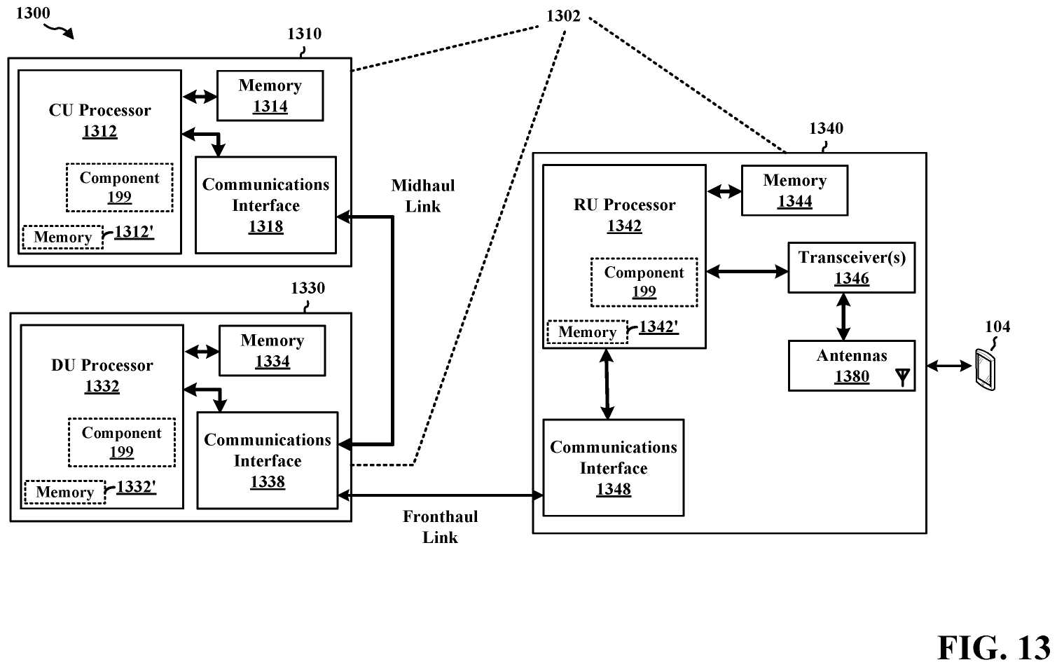

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, DFT-s-OFDM component 199 may be configured to receive, at connection establishment with a UE, a capability indication representing a support for multiple DFT or multiple IDFT for DFT-s-OFDM. In some aspects, the DFT-s-OFDM component 199 may be further configured to transmit an activation associated with the multiple DFT or the multiple IDFT for the UE, the activation indicating two or more BWPs. In some aspects, the DFT-s-OFDM component 199 may be further configured to transmit or receive a DFT-s-OFDM waveform associated with a dedicated DFT or a dedicated IDFT in each of the two or more BWPs. The DFT-s-OFDM component 199 may be within one or more processors of one or more of the CU 1310, DU 1330, and the RU 1340. The DFT-s-OFDM component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In some aspects, the network entity 1302 includes means for receiving, at connection establishment with a UE, a capability indication representing a support for multiple DFT or multiple IDFT for DFT-s-OFDM. In some aspects, the network entity 1302 may further include means for transmitting an activation associated with the multiple DFT or the multiple IDFT for the UE, the activation indicating two or more BWPs. In some aspects, the network entity 1302 may further include means for transmitting or receiving a DFT-s-OFDM waveform associated with a dedicated DFT or a dedicated IDFT in each of the two or more BWPs. In some aspects, the network entity 1302 may further include means for using an output of a fast Fourier transform (IFFT) as an input to a first IDFT and a second IDFT to receive a time domain waveform for each BWP of the two or more BWPs. In some aspects, the network entity 1302 may further include means for demapping portions of the DFT-s-OFDM waveform for each of the two or more BWPs. In some aspects, the network entity 1302 may further include means for performing the first IDFT on a first portion of the signal in a first BWP of the two or more BWPs to obtain a first bitstream. In some aspects, the network entity 1302 may further include means for performing the second IDFT on a second portion of the signal in a second BWP of the two or more BWPs to obtain a second bitstream. In some aspects, the network entity 1302 may further include means for performing a first DFT on a first bitstream to be transmitted in a first BWP of the two or more BWPs. In some aspects, the network entity 1302 may further include means for performing a second DFT on a second bitstream to be transmitted in a second BWP of the two or more BWPs. In some aspects, the network entity 1302 may further include means for using an output of the first DFT and the second DFT as an input for an inverse fast Fourier transform (IFFT) to transmit a time domain waveform for each BWP of the two or more BWPs. In some aspects, the network entity 1302 may further include means for receiving channel state information reference signals (CSI-RS) based on the CQI, the PMI, or the RI associated with each BWP of the two or more BWPs. In some aspects, the network entity 1302 may further include means for transmitting, in downlink control information (DCI) associated with the DFT-s-OFDM waveform associated with the multiple DFT or the multiple IDFT, a modulation and coding scheme (MCS) of each BWP of the two or more BWPs, where the DCI includes multiple DCI associated with multiple component carriers (CCs) associated with the two or more BWPs. In some aspects, the network entity 1302 may further include means for transmitting a deactivation associated with the multiple DFT or the multiple IDFT for the UE, where the deactivation further indicates one BWP. In some aspects, the network entity 1302 may further include means for transmitting DFT-s-ODFM waveform associated with the one BWP. The means may be the DFT-s-OFDM component 199 of the network entity 1302 configured to perform the functions recited by the means. As described herein, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method for communication at a user equipment (UE), including: transmitting a capability indication associated with a support for multiple discrete Fourier transform (DFT) or multiple inverse discrete Fourier transform (IDFT) for DFT spread orthogonal frequency division multiplexing (DFT-s-OFDM) to a network entity; receiving an activation associated with the multiple DFT or the multiple IDFT from the network entity, the activation indicating two or more bandwidth parts (BWPs); and transmitting or receiving a DFT-s-OFDM waveform associated with the multiple DFT or the multiple IDFT in the two or more BWPs with a dedicated DFT or a dedicated IDFT for each BWP of the two or more BWPs.

Aspect 2 is the method of aspect 1, where the capability indication further includes a number of simultaneous bandwidth parts (BWPs) supported by the UE, and where the number of simultaneous BWPs supported by the UE is equal to a number of the multiple DFT or the multiple IDFT.

Aspect 3 is the method of any of aspects 1-2, where the capability indication is further associated with one or more frequency locations associated with one or more BWPs associated with the number of simultaneous BWPs.

Aspect 4 is the method of any of aspects 1-3, where the one or more frequency locations are based on one or more channel state information reference signals (CSI-RS) or one or more demodulation reference signals (DM-RS).

Aspect 5 is the method of any of aspects 1-4, where the activation further indicates a set of locations associated with the two or more BWPs.

Aspect 6 is the method of any of aspects 1-5, where the two or more BWPs are associated with a same layer or different layers.

Aspect 7 is the method of any of aspects 1-6, where the at least one processor is configured to receive the DFT-s-OFDM waveform associated with the multiple IDFT in each BWP of the two or more BWPs, and further including: demapping portions of the DFT-s-OFDM waveform for each of the two or more BWPs to generate a signal; performing a first IDFT on a first portion of the signal in a first BWP of the two or more BWPs to obtain a first bitstream; and performing a second IDFT on a second portion of the signal in a second BWP of the two or more BWPs to obtain a second bitstream.

Aspect 8 is the method of any of aspects 1-7, further including: using an output of a fast Fourier transform (FFT) as an input to the first IDFT and the second IDFT to receive a time domain waveform for each BWP of the two or more BWPs.

Aspect 9 is the method of any of aspects 1-8, where the at least one processor is configured to transmit the DFT-s-OFDM waveform associated with the multiple DFT in each BWP of the two or more BWPs, and further including: performing a first DFT on a first bitstream to be transmitted in a first BWP of the two or more BWPs; and performing a second DFT on a second bitstream to be transmitted in a second BWP of the two or more BWPs.

Aspect 10 is the method of any of aspects 1-9, further including: using an output of the first DFT and the second DFT as an input for an inverse fast Fourier transform (IFFT) to transmit a time domain waveform for each BWP of the two or more BWPs.

Aspect 11 is the method of any of aspects 1-10, where further including: transmitting a channel quality indicator (CQI), a pre-coding matrix indicator (PMI), or a rank indicator (RI) associated with each BWP of the two or more BWPs to the network entity.

Aspect 12 is the method of any of aspects 1-11, where further including: receiving channel state information reference signals (CSI-RS) from the network entity based on the CQI, the PMI, or the RI associated with each BWP of the two or more BWPs.

Aspect 13 is the method of any of aspects 1-12, where further including: receiving, in downlink control information (DCI) associated with the DFT-s-OFDM waveform associated with the multiple DFT or the multiple IDFT, a modulation and coding scheme (MCS) of each BWP of the two or more BWPs from the network entity.

Aspect 14 is the method of any of aspects 1-13, where the DCI includes multiple DCI associated with multiple component carriers (CCs) associated with the two or more BWPs.

Aspect 15 is the method of any of aspects 1-14, where further including: receiving a deactivation associated with the multiple DFT or the multiple IDFT from the network entity, where the deactivation further indicates one BWP.

Aspect 16 is the method of any of aspects 1-15, where further including: receiving a second DFT-s-ODFM waveform associated with the one BWP from the network entity.

Aspect 17 is the method of any of aspects 1-16, where further including: transmitting, to the network entity, a performance report associated with the multiple DFT or the multiple IDFT.

Aspect 18 is the method of any of aspects 1-17, the method being performed at a UE with at least one of a transceiver or an antenna coupled to at least one processor and configured to receive the DFT-s-OFDM waveform.

Aspect 19 is a method for communication at a network entity, including: receiving, at connection establishment with a user equipment (UE), a capability indication associated with a support for multiple discrete Fourier transform (DFT) or multiple inverse discrete Fourier transform (IDFT) for DFT spread orthogonal frequency division multiplexing (DFT-s-OFDM); transmitting an activation associated with the multiple DFT or the multiple IDFT for the UE, the activation indicating two or more bandwidth parts (BWPs); and transmitting or receiving a DFT-s-OFDM waveform associated with a dedicated DFT or a dedicated IDFT in each of the two or more BWPs.

Aspect 20 is the method of aspect 19, where the capability indication further includes a number of simultaneous bandwidth parts (BWPs) supported by the UE, and where the number of simultaneous BWPs supported by the UE is equal to a number of the multiple DFT or the multiple IDFT, and where the capability indication is further associated with one or more frequency locations associated with one or more BWPs associated with the number of simultaneous BWPs.

Aspect 21 is the method of any of aspects 19-20, where the one or more frequency locations are based on one or more channel state information reference signals (CSI-RS) or one or more demodulation reference signals (DM-RS).

Aspect 22 is the method of any of aspects 19-21, where the activation further indicates a set of locations associated with the two or more BWPs, and where the two or more BWPs are associated with a same layer or different layers.

Aspect 23 is the method of any of aspects 19-22, where the at least one processor is configured to receive the DFT-s-OFDM waveform associated with the multiple IDFT in each BWP of the two or more BWPs, and further including: using an output of a fast Fourier transform (FFT) as an input to a first IDFT and a second IDFT to receive a time domain waveform for each BWP of the two or more BWPs; demapping portions of the DFT-s-OFDM waveform for each of the two or more BWPs to generate a signal; performing the first IDFT on a first portion of the signal in a first BWP of the two or more BWPs to obtain a first bitstream; and performing the second IDFT on a second portion of the signal in a second BWP of the two or more BWPs to obtain a second bitstream.

Aspect 24 is the method of any of aspects 19-23, where the at least one processor is configured to transmit the DFT-s-OFDM waveform associated with the multiple DFT in each BWP of the two or more BWPs, and further including: performing a first DFT on a first bitstream to be transmitted in a first BWP of the two or more BWPs; performing a second DFT on a second bitstream to be transmitted in a second BWP of the two or more BWPs; and using an output of the first DFT and the second DFT as an input for an inverse fast Fourier transform (IFFT) to transmit a time domain waveform for each BWP of the two or more BWPs.

Aspect 25 is the method of any of aspects 19-24, where further including: receiving a channel quality indicator (CQI), a pre-coding matrix indicator (PMI), or a rank indicator (RI) associated with each BWP of the two or more BWPs, where further including: receiving channel state information reference signals (CSI-RS) based on the CQI, the PMI, or the RI associated with each BWP of the two or more BWPs.

Aspect 26 is the method of any of aspects 19-25, where further including: transmitting, in downlink control information (DCI) associated with the DFT-s-OFDM waveform associated with the multiple DFT or the multiple IDFT, a modulation and coding scheme (MCS) of each BWP of the two or more BWPs, where the DCI includes multiple DCI associated with multiple component carriers (CCs) associated with the two or more BWPs.

Aspect 27 is the method of any of aspects 19-26, where further including: transmitting a deactivation associated with the multiple DFT or the multiple IDFT for the UE, where the deactivation further indicates one BWP; and transmitting DFT-s-ODFM waveform associated with the one BWP.

Aspect 28 is the method of any of aspects 19-27, the method being performed at a base station with at least one of a transceiver or an antenna coupled to at least one processor and configured to transmit the DFT-s-OFDM waveform associated with the multiple DFT or the multiple IDFT.

Aspect 29 is an apparatus for wireless communication at a UE including a memory and at least one processor coupled to the memory and, based at least in part on information stored in the memory, configured to perform a method in accordance with any of aspects 1-18. The apparatus may include at least one of a transceiver or an antenna coupled to the at least one processor.

Aspect 30 is an apparatus for wireless communication, including means for performing a method in accordance with any of aspects 1-18.

Aspect 31 is a non-transitory computer-readable medium including instructions that, when executed by an apparatus, cause the apparatus to perform a method in accordance with any of aspects 1-18.

Aspect 32 is an apparatus for wireless communication at a network entity including a memory and at least one processor coupled to the memory and, based at least in part on information stored in the memory, configured to perform a method in accordance with any of aspects 19-28. The apparatus may include at least one of a transceiver or an antenna coupled to the at least one processor.

Aspect 33 is an apparatus for wireless communication, including means for performing a method in accordance with any of aspects 19-28.

Aspect 34 is a non-transitory computer-readable medium including instructions that, when executed by an apparatus, cause the apparatus to perform a method in accordance with any of aspects 19-28.

What is claimed is:

1. An apparatus for communication at a user equipment (UE), comprising:
a memory; and
at least one processor coupled to the memory and, based at least in part on information stored in the memory, the at least one processor is configured to:
transmit a capability indication associated with a support for multiple discrete Fourier transform (DFT) or multiple inverse discrete Fourier transform (IDFT) for DFT spread orthogonal frequency division multiplexing (DFT-s-OFDM) to a network entity;
receive an activation associated with the multiple DFT or the multiple IDFT from the network entity, the activation indicating two or more bandwidth parts (BWPs); and
transmit or receive a DFT-s-OFDM waveform associated with the multiple DFT or the multiple IDFT in the two or more BWPs with a dedicated DFT or a dedicated IDFT for each BWP of the two or more BWPs.

2. The apparatus of claim 1, wherein the capability indication further comprises a number of simultaneous bandwidth parts (BWPs) supported by the UE, and wherein the number of simultaneous BWPs supported by the UE is equal to a number of the multiple DFT or the multiple IDFT.

3. The apparatus of claim 2, wherein the capability indication is further associated with one or more frequency locations associated with one or more BWPs associated with the number of simultaneous BWPs.

4. The apparatus of claim 3, wherein the one or more frequency locations are based on one or more channel state information reference signals (CSI-RS) or one or more demodulation reference signals (DM-RS).

5. The apparatus of claim 1, wherein the activation further indicates a set of locations associated with the two or more BWPs.

6. The apparatus of claim 5, wherein the two or more BWPs are associated with a same layer or different layers.

7. The apparatus of claim 1, wherein the at least one processor is configured to receive the DFT-s-OFDM waveform associated with the multiple IDFT in each BWP of the two or more BWPs, and the at least one processor is further configured to:
demap portions of the DFT-s-OFDM waveform for each of the two or more BWPs to generate a signal;
perform a first IDFT on a first portion of the signal in a first BWP of the two or more BWPs to obtain a first bitstream; and
perform a second IDFT on a second portion of the signal in a second BWP of the two or more BWPs to obtain a second bitstream.

8. The apparatus of claim 7, the at least one processor is further configured to:
use an output of a fast Fourier transform (FFT) as an input to the first IDFT and the second IDFT to receive a time domain waveform for each BWP of the two or more BWPs.

9. The apparatus of claim 1, wherein the at least one processor is configured to transmit the DFT-s-OFDM waveform associated with the multiple DFT in each BWP of the two or more BWPs, and the at least one processor is further configured to:
perform a first DFT on a first bitstream to be transmitted in a first BWP of the two or more BWPs; and
perform a second DFT on a second bitstream to be transmitted in a second BWP of the two or more BWPs.

10. The apparatus of claim 9, the at least one processor is further configured to:
use an output of the first DFT and the second DFT as an input for an inverse fast Fourier transform (IFFT) to transmit a time domain waveform for each BWP of the two or more BWPs.

11. The apparatus of claim 1, wherein the at least one processor is further configured to:
transmit a channel quality indicator (CQI), a pre-coding matrix indicator (PMI), or a rank indicator (RI) associated with each BWP of the two or more BWPs to the network entity.

12. The apparatus of claim 11, wherein the at least one processor is further configured to:
receive channel state information reference signals (CSI-RS) from the network entity based on the CQI, the PMI, or the RI associated with each BWP of the two or more BWPs.

13. The apparatus of claim 1, wherein the at least one processor is further configured to:
receive, in downlink control information (DCI) associated with the DFT-s-OFDM waveform associated with the multiple DFT or the multiple IDFT, a modulation and coding scheme (MCS) of each BWP of the two or more BWPs from the network entity.

14. The apparatus of claim 13, wherein the DCI comprises multiple DCI associated with multiple component carriers (CCs) associated with the two or more BWPs.

15. The apparatus of claim 1, wherein the at least one processor is further configured to:
receive a deactivation associated with the multiple DFT or the multiple IDFT from the network entity, wherein the deactivation further indicates one BWP.

16. The apparatus of claim 15, wherein the at least one processor is further configured to:
receive a second DFT-s-ODFM waveform associated with the one BWP from the network entity.

17. The apparatus of claim 1, wherein the at least one processor is further configured to:
transmit, to the network entity, a performance report associated with the multiple DFT or the multiple IDFT.

18. The apparatus of claim 1, further comprising at least one of a transceiver or an antenna coupled to the at least one processor and configured to receive the DFT-s-OFDM waveform.

19. An apparatus for communication at a network entity, comprising:
a memory; and
at least one processor coupled to the memory and, based at least in part on information stored in the memory, the at least one processor is configured to:
receive, at connection establishment with a user equipment (UE), a capability indication associated with a support for multiple discrete Fourier transform (DFT) or multiple inverse discrete Fourier transform (IDFT) for DFT spread orthogonal frequency division multiplexing (DFT-s-OFDM);
transmit an activation associated with the multiple DFT or the multiple IDFT for the UE, the activation indicating two or more bandwidth parts (BWPs); and
transmit or receive a DFT-s-OFDM waveform associated with a dedicated DFT or a dedicated IDFT in each of the two or more BWPs.

20. The apparatus of claim 19, wherein the capability indication further comprises a number of simultaneous bandwidth parts (BWPs) supported by the UE, and wherein the number of simultaneous BWPs supported by the UE is equal to a number of the multiple DFT or the multiple IDFT, and wherein the capability indication is further associated with one or more frequency locations associated with one or more BWPs associated with the number of simultaneous BWPs.

21. The apparatus of claim 20, wherein the one or more frequency locations are based on one or more channel state information reference signals (CSI-RS) or one or more demodulation reference signals (DM-RS).

22. The apparatus of claim 19, wherein the activation further indicates a set of locations associated with the two or more BWPs, and wherein the two or more BWPs are associated with a same layer or different layers.

23. The apparatus of claim 19, wherein the at least one processor is configured to receive the DFT-s-OFDM waveform associated with the multiple IDFT in each BWP of the two or more BWPs, and the at least one processor is further configured to:
use an output of a fast Fourier transform (FFT) as an input to a first IDFT and a second IDFT to receive a time domain waveform for each BWP of the two or more BWPs;
demap portions of the DFT-s-OFDM waveform for each of the two or more BWPs to generate a signal;
perform the first IDFT on a first portion of the signal in a first BWP of the two or more BWPs to obtain a first bitstream; and
perform the second IDFT on a second portion of the signal in a second BWP of the two or more BWPs to obtain a second bitstream.

24. The apparatus of claim 19, wherein the at least one processor is configured to transmit the DFT-s-OFDM waveform associated with the multiple DFT in each BWP of the two or more BWPs, and the at least one processor is further configured to:
perform a first DFT on a first bitstream to be transmitted in a first BWP of the two or more BWPs;
perform a second DFT on a second bitstream to be transmitted in a second BWP of the two or more BWPs; and
use an output of the first DFT and the second DFT as an input for an inverse fast Fourier transform (IFFT) to transmit a time domain waveform for each BWP of the two or more BWPs.

25. The apparatus of claim 19, wherein the at least one processor is further configured to:
receive a channel quality indicator (CQI), a pre-coding matrix indicator (PMI), or a rank indicator (RI) associated with each BWP of the two or more BWPs, wherein the at least one processor is further configured to:
receive channel state information reference signals (CSI-RS) based on the CQI, the PMI, or the RI associated with each BWP of the two or more BWPs.

26. The apparatus of claim 19, wherein the at least one processor is further configured to:
transmit, in downlink control information (DCI) associated with the DFT-s-OFDM waveform associated with the multiple DFT or the multiple IDFT, a modulation and coding scheme (MCS) of each BWP of the two or more BWPs, wherein the DCI comprises multiple DCI associated with multiple component carriers (CCs) associated with the two or more BWPs.

27. The apparatus of claim 19, wherein the at least one processor is further configured to:
transmit a deactivation associated with the multiple DFT or the multiple IDFT for the UE, wherein the deactivation further indicates one BWP; and
transmit DFT-s-ODFM waveform associated with the one BWP.

28. The apparatus of claim 19, further comprising at least one of a transceiver or an antenna coupled to the at least one processor and configured to transmit the DFT-s-OFDM waveform associated with the multiple DFT or the multiple IDFT.

29. A method for communication at a user equipment (UE), comprising:
transmitting a capability indication associated with a support for multiple discrete Fourier transform (DFT) or multiple inverse discrete Fourier transform (IDFT) for DFT spread orthogonal frequency division multiplexing (DFT-s-OFDM) to a network entity;
receiving an activation associated with the multiple DFT or the multiple IDFT from the network entity, the activation indicating two or more bandwidth parts (BWPs); and
transmitting or receiving a DFT-s-OFDM waveform associated with the multiple DFT or the multiple IDFT in the two or more BWPs with a dedicated DFT or a dedicated IDFT for each BWP of the two or more BWPs.

30. A method for communication at a network entity, comprising:
receiving, at connection establishment with a user equipment (UE), a capability indication associated with a support for multiple discrete Fourier transform (DFT) or multiple inverse discrete Fourier transform (IDFT) for DFT spread orthogonal frequency division multiplexing (DFT-s-OFDM);
transmitting an activation associated with the multiple DFT or the multiple IDFT for the UE, the activation indicating two or more bandwidth parts (BWPs); and
transmitting or receiving a DFT-s-OFDM waveform associated with a dedicated DFT or a dedicated IDFT in each of the two or more BWPs.
